(19) United States
(12) Patent Application Publication
(10) Pub. No.: US 2025/0388987 A1
(43) Pub. Date: Dec. 25, 2025

(54) Methods for Improved Carbon Endpoint Determination

(71) Applicants: Victor H. Hernandez Avila, Tonawanda, NY (US); Gerardo Vallejo Rivero, Tonawanda, NY (US); Joseph A. Maiolo, Tonawanda, NY (US)

(72) Inventors: Victor H. Hernandez Avila, Tonawanda, NY (US); Gerardo Vallejo Rivero, Tonawanda, NY (US); Joseph A. Maiolo, Tonawanda, NY (US)

(21) Appl. No.: 19/227,841

(22) Filed: Jun. 4, 2025

Related U.S. Application Data
(60) Provisional application No. 63/662,141, filed on Jun. 20, 2024.

(51) Int. Cl. C21C 7/068

(52) U.S. Cl. CPC C21C 7/068; C21C 2300/06

(57) ABSTRACT

The present invention generally relates to methods for determining an improved carbon endpoint concentration in an argon oxygen decarburization process. The present invention utilizes various pieces of real-time data, including parameters of the flame and soot content to estimate a carbon composition in the steel product, along with two other metallurgical models to generate corresponding carbon compositions in the steel product. A total of 3 carbon compositions are determined and continuously updated during the process. An improved carbon endpoint value is determined to be reached when at least a first value and a second value corresponding to any of the three carbon compositions are below a target carbon value. Upon such condition being satisfied, an alert notification is transmitted to enable carbon sampling to confirm that the sample has a measured carbon concentration that is below a predetermined calculated target carbon value.

### RELATED APPLICATIONS

This application claims the benefit of priority to U.S. Provisional Application Ser. No. 63/662,141, filed on Jun. 20, 2024, which is incorporated herein by reference in its entirety for all purposes.

### FIELD OF THE INVENTION

The present invention generally relates to estimating when to take a carbon sample during an argon oxygen decarburization (AOD) process. More particularly, the present invention relates to utilizing various models to calculate and/or determine carbon concentrations during the AOD process. The various carbon concentrations are compared with each other to determine when a carbon sample should be obtained.

### BACKGROUND OF THE INVENTION

Oxygen steelmaking for argon oxygen decarburization (AOD) processes require the ability to predict with sufficient accuracy when a relatively low target carbon content of the steel has been reached for purposes of knowing when to take a carbon sample from the AOD vessel (e.g., furnace). Generally speaking, in the AOD operation, there is a sequence of steps for processing each steel product batch (i.e., product batch is also referred to herein and throughout as a “heat”). The processing of the heat begins with building a slag and injecting oxygen gas and inert gas. Oxygen and inert gas (e.g., argon or nitrogen) are injected to begin the process of removing a majority of the carbon from the metal bath. Typically, the volumetric ratio of oxygen to inert gas is 3:1 or greater. As the processing of the heat progresses, slag builders, alloys, (e.g., ferrochrome, ferronickel and others), and heating alloys, (e.g., aluminum), can be added. The oxygen to inert gas volumetric ratio is decreased throughout the AOD process until a volumetric ratio of oxygen to inert gas of about 1:3 is reached. During this ramp down sequence, as the volumetric ratio of oxygen to inert gas is reduced to about 1:1, the carbon content is also typically reduced from about 0.2 wt. % to values of about 0.1 wt. % or lower. When the carbon is reduced to below 0.1 wt. %, the oxygen to inert gas volumetric ratio is reduced to about 1:3. An oxygen to inert gas volumetric ratio of 1:3, in many instances, will create a carbon content that approaches about 0.02 wt. %. This processing of the heat for lowering of carbon is typically referred to as “decarburization” in the industry. In a decarburization process, the typical steel product specifications require the target carbon content at levels below 0.1 wt. %.

However, the actual carbon composition of the heat is unknown during the AOD heat processing until a sample is taken and analyzed. Difficulties reside in the operator knowing when to take the sample as the operator needs to have an accurate estimate of the steel composition on a dashboard to know when to take make the decision to stop the process and take a sample. Prematurely taking a sample and determining the sample has a measured carbon concentration above the target carbon content requires restarting the AOD process to continue the removal of the carbon levels in the steel product until the carbon target is reached. Restarting the AOD process lengthens the overall duration of the AOD process and can detrimentally reduce throughput.

To overcome the above challenges, operators have relied upon both mathematical models and an observation of the flame characteristics for estimation of actual carbon content in the heat based on so-called “carbon endpoint values.” The “carbon endpoint value” or “carbon endpoint” as used in typical AOD processes has been based on predicting carbon values based on any number of parameters with conventional modelling that estimate the concentration of the carbon in the heat. The carbon endpoint is required feedback for the operator to use during the AOD process to determine when to stop the AOD process and take a carbon sample of the heat inside the AOD furnace.

Although the carbon endpoint is a key piece of data, the current carbon endpoint values have not proven as reliable indicators for determining when to take a carbon sample of the heat. The carbon endpoint values are in many instances higher than the actual carbon concentrations measured in the heat, thereby necessitating resuming the AOD process to lower the carbon content of the heat. Additionally, the carbon endpoint values vary depending on the mathematical models being utilized. If multiple models are being relied upon by the operator, the operator does not know with certainty which value to rely upon as the most reliable and accurate carbon endpoint value, especially when there is significant variation of calculated carbon concentrations between each of the models. Current techniques for carbon endpoint are therefore not accurate estimations of the actual carbon content in the heats.

In view of these drawbacks, there is an unmet need for improved carbon endpoint methodologies that yield more accurate estimates of the measured carbon concentration in the heat in a simplified manner for a user.

### SUMMARY OF THE INVENTION

The invention may include any of the following aspects in various combinations and may also include any other aspect of the present invention described below in the written description.

Other aspects, features and embodiments of the disclosure will be more fully apparent from the ensuing description and appended claims.

In a first aspect, a method of determining an improved carbon endpoint value during an argon oxygen decarburization (AOD) process, comprising: initiating the AOD process by feeding a predetermined weight of a molten metal charge, and flowing oxygen gas, nitrogen gas and argon gas in controlled ratios into an AOD vessel; generating a flame produced by chemical reactions above the molten metal charge and a slag charge; removing carbon from a molten metal bath produced in the AOD vessel from the molten metal charge; calculating a first carbon composition in the molten metal bath in a controller; generating a first output signal corresponding to the first carbon composition and transmitting said first output signal to a human-machine interface (HMI); calculating a second carbon composition in the molten metal bath based on receiving operating parameters from the controller and/or an on-premise plant database; generating a second output signal corresponding to the second carbon composition and transmitting said second output signal to the HMI; determining a third carbon composition in the molten metal charge based on performing fuzzy logic analysis on parameters of the flame and receiving a calculated value of CO; generating a third output signal corresponding to the third carbon composition and transmitting said third output signal to the HMI; and determining in real-time that the improved carbon endpoint value is reached when at least a first value and a second value corresponding to any of the first carbon composition, the second carbon composition and the third carbon composition are below a predetermined calculated target carbon value.

In a second aspect, a method of determining a carbon composition during an argon oxygen decarburization (AOD) process, comprising: initiating the AOD process by feeding a predetermined weight of a molten metal charge, and flowing oxygen gas, nitrogen gas and argon gas in controlled ratios into an AOD vessel; generating a flame produced by chemical reactions above the molten metal charge and a slag charge; removing carbon from the molten metal bath produced in the AOD vessel from the molten metal charge; receiving a fuzzy logic output characterized as a carbon end-point score of the flame; receiving a calculated value for a composition of CO; utilizing the calculated value for the composition of CO to calculate a soot concentration in the flame; utilizing a function of the normalized soot concentration to convert the end-point carbon score into a final carbon score of the flame that is a single value being a dimensionless parameter having a value greater than 0 and below 100; and empirically correlating the final carbon score to a carbon content in the molten metal bath.

In a third aspect, a method of estimating an improved carbon end point value during an argon oxygen decarburization (AOD) process, comprising: feeding a predetermined weight of a molten metal charge, a slag charge and flowing oxygen gas, nitrogen gas and argon gas in controlled ratios into an AOD vessel; generating a flame produced by chemical reactions above the molten metal charge and the slag charge; removing carbon from a molten metal bath produced in the AOD vessel from the molten metal charge; receiving an alert notification that a sample of carbon from the molten metal bath in the AOD vessel is ready to be obtained; and in response thereto; stopping flow of the oxygen gas, the nitrogen gas and the argon gas to the AOD vessel; obtaining the sample of the carbon from the molten steel bath in the AOD vessel; and measuring the carbon content in the sample; and determining the measured carbon content in the sample is reduced to a level that is below a predetermined calculated target carbon value.

In a fourth aspect, a method of determining an improved carbon endpoint value during an argon oxygen decarburization (AOD) process, comprising: initiating the AOD process by feeding a predetermined weight of a molten metal charge, and flowing oxygen gas, nitrogen gas and argon gas in controlled ratios into an AOD vessel; generating a flame produced by chemical reactions above the molten metal charge and a slag charge; removing carbon from a molten metal bath produced in the AOD vessel from the molten metal charge; calculating a first carbon composition in the molten metal bath in a controller; calculating a second carbon composition in the molten metal bath based on receiving operating parameters from the controller and/or an on-premise plant database; determining a third carbon composition in the molten metal charge based on performing fuzzy logic analysis on parameters of the flame and receiving a calculated value of CO; and generating a visual output to the HMI that indicates a sample of the molten steel bath in the AOD vessel is ready to be obtained when at least a first value and a second value corresponding to any of the first carbon composition, the second carbon composition and the third carbon composition are below a predetermined calculated target carbon value.

### BRIEF DESCRIPTION OF THE DRAWINGS

The objectives and advantages of the invention will be better understood from the following detailed description of the preferred embodiments thereof in connection with the accompanying figures wherein like numbers denote same features throughout and wherein:

FIG. 1 shows representative methodology in accordance with the principles of the present invention that may be employed in estimating a reliable and accurate improved carbon endpoint value;

FIG. 2 shows a representative dashboard updated in real-time that an operator utilizes to carry out the AOD process, whereby the dashboard includes a visual output that indicates when to take a carbon sample; and

FIG. 3 shows an image of the flame that has been partitioned into seven zones as part of a fuzzy logic algorithm for establishing a numerical carbon score for each zone and a resultant carbon score (i.e., endpoint carbon score) of the entire flame based on certain parameters of the flame; and

FIG. 4 shows a representative non-exhaustive list of the types of parameters that can be read from a programmable logic controller (PLC) in connection with one of the models utilized to carry out the present invention.

### DETAILED DESCRIPTION OF THE INVENTION

The relationship and functioning of the various elements of the embodiments are better understood by the following detailed description. The detailed description contemplates the features, aspects and embodiments in various permutations and combinations, as being within the scope of the disclosure. The disclosure may therefore be specified as comprising, consisting or consisting essentially of, any of such combinations and permutations of these specific features, aspects and embodiments, or a selected one or ones thereof.

All concentrations used herein and throughout are expressed as weight percentages, unless expressly stated otherwise. The terms “concentration” and “content” may be used interchangeably herein and throughout and are intended to have the same meaning. The term “carbon value” is used herein and throughout and is intended to refer to a carbon concentration.

Where a range of values describes a parameter (e.g., physical properties, measured variables or dimensions), all sub-ranges, point values within that range and endpoints defining a range are explicitly disclosed therein.

The drawings are for the purpose of illustrating the invention and are not intended to be drawn to scale. The embodiments are described with reference to the drawings in which similar elements are referred to by like numerals. Certain features may be intentionally omitted in each of the drawings to better illustrate various aspects of the methods for estimating an improved carbon endpoint value, in accordance with the principles of the present invention. The embodiments are described by way of example only, and the invention is not limited to the embodiments illustrated in the drawings.

As used herein and throughout, the term “real-time” means a parameter that is updated every 20 seconds or less during the process. The real-time concentration can be calculated by a module and/or pulled from an onsite database or controller (e.g., PLC).

As used herein and throughout, the term “liquid pool,” “liquid bath” and “molten bath” shall be used interchangeably and have the same meaning. The present invention has emerged as a result of the inability to accurately predict the carbon endpoint during an AOD process. Contrary to prior systems utilized for modeling the carbon content in AOD processes, the present invention does not rely exclusively on the flame characteristics to correlate carbon content in the flame to the carbon endpoint content in the steel product. The inventors have recognized that a steel carbon concentration does not necessarily correlate to a single unique carbon monoxide content in the flame. The emergence of the so-called “carbon vision” methodology takes into consideration the various inaccuracies of prior methods to predict with more accuracy carbon concentrations, which when compared with other carbon concentrations generated from other modules, can yield an improved carbon endpoint value when a majority of the calculated carbon concentrations are determined to have a concentration that is below a predetermined calculated target carbon value. The term “improved carbon endpoint” or “improved carbon endpoint value” as used herein and throughout serves as a critical indicator that provides feedback in real-time for the operator to use during the AOD process to determine when to stop the AOD process and take a carbon measured sample of the heat inside the AOD furnace. The improved carbon endpoint is based on calculated carbon values from several parameters of multiple models, one of which includes a carbon vision module (as will be explained hereinbelow), whereby each of said models calculates the concentration of carbon in the heat. Different models can calculate different real-time carbon concentrations. The improved carbon endpoint is detected when a majority of the calculated real-time carbon values are determined to be below a predetermined calculated target carbon value.

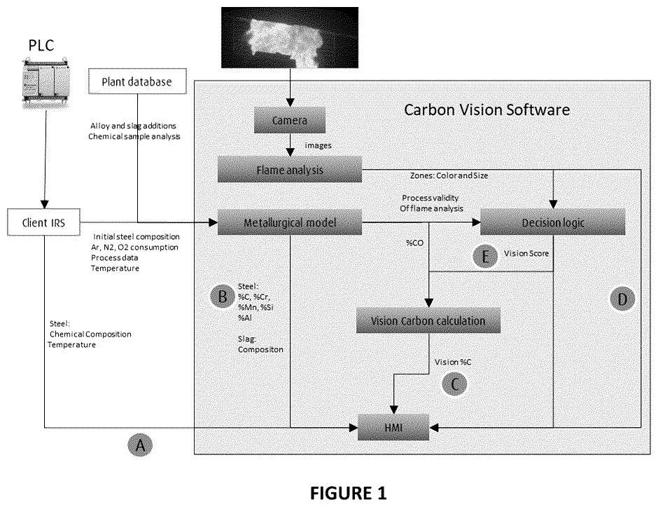

FIG. 1 shows an exemplary system exhibiting unique modelling methodology that is employed in accordance with the principles of the present invention. Generally speaking, a novel carbon vision module utilizes incoming parameters of a calculated offgas CO concentration and an endpoint carbon score of the flame to calculate a predicted real-time concentration of carbon in the heat. The calculated offgas CO concentration is received from a metallurgical model module and the endpoint carbon score of the flame is received from a fuzzy logic module (i.e., decision logic module as labelled in FIG. 1). As will be explained, (i) the output carbon value generated by the carbon vision module in combination with (ii) a calculated carbon value generated by the metallurgical model and (iii) a carbon value that is calculated in the controller and then transmitted to the IRS module (described further hereinbelow), are compared to a predetermined calculated target carbon value to determine with greater accuracy and consistency when an improved carbon endpoint value in a particular heat has been reached. Upon determining the improved carbon endpoint value has been reached, the system transmits a visual signal to a human machine interface (“HMI”), thereby notifying an operator to stop the AOD process and take a carbon sample of the heat for measurement. The various algorithm modules involved in the determination of the improved carbon endpoint will now be described.

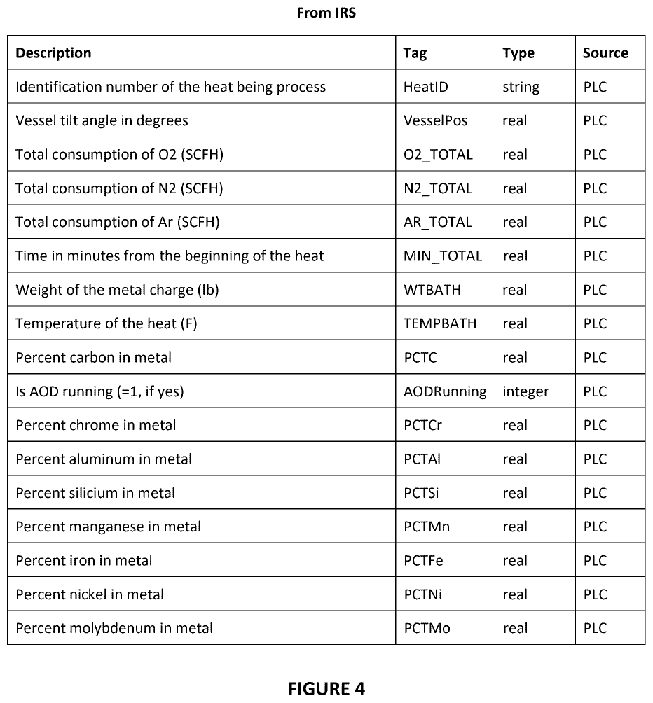

The metallurgical model module receives parameters from the IRS module which includes calculation or determination of the initial and real-time compositions of the steel along with the argon, nitrogen and oxygen process gases that are consumed during the AOD process. FIG. 1 shows that the IRS module can read the required parameters utilized by the metallurgical model from a controller (e.g., PLC located onsite). A representative non-exhaustive list of the types of parameters that can be read from a PLC (including the calculated carbon value) is shown in FIG. 4. The IRS module is commercially available as the Linde AOD IRS system. Such parameters, including additional operating parameters, such as alloy and slag additions, can be separately transmitted from an on-premise plant database (i.e., at the site where the AOD furnace is located) to the metallurgical model module. The IRS module transmits the real-time composition of the steel, as designated by “A” in FIG. 1, to the HMI. The real-time composition of the steel includes a real-time carbon concentration.

Having received the aforementioned parameters, the metallurgical model module generates the output data designated as “B” in FIG. 1 by simulating the AOD process as three reaction zones on-going during the AOD process, namely the (1) zone of gas injected steel (i.e., a mixture of argon and oxygen injected with the molten steel charge); (2) zone of slag; and (3) zone of alloy (hereinafter referred to as “reaction zone (1),” “reaction zone (2”) and “reaction zone (3),” respectively.) In particular, the metallurgical model mathematically simulates the mass transfer and energy transfer in these reaction zones (1), (2) and (3).

The metallurgical model is defined as a multi-component, multi-phase system defined by reaction zones (1), (2) and (3). The modelling takes into consideration the elements of the compounds that are in each of reaction zones (1), (2) and (3) and further assumes they are in equilibrium with each other. The metallurgical model simultaneously performs mass balance and energy balance computations for all of the equilibrium equations; the equilibrium equations are based on the Gibbs free energy equations by minimizing the total Gibbs free energy to achieve the system equilibrium in the reaction zones. The result of the equations is a calculated equilibrium composition of the steel, gas and slag.

When oxygen gas and inert gas are injected into the AOD furnace, the thermodynamic modelling is performed for each of reaction zones (1), (2) and (3). When there is no oxygen gas being introduced during the AOD furnace, the thermodynamic modelling is performed for each of reaction zones (2) and (3). Alternatively, if no oxygen gas is introduced, and the contents in the furnace no longer contain alloys, only reaction zone (2) is utilized for performing the thermodynamic modelling. Of particular significance, the metallurgical model module calculates various real-time chemistries in the steel composition and the slag, including a real-time carbon concentration in the steel, which is relayed to an HMI, as part of the transmitted data designated as “B” in FIG. 1.

The metallurgical model module also generates a third output signal as shown in FIG. 1 involving offgas CO concentration that is calculated in real-time from the thermodynamic modelling described hereinabove. The offgas CO is produced during the AOD process and represents the CO content of the flame during the AOD process. This output signal corresponding to the offgas CO concentration (labelled as “%CO: FIG. 1) is transmitted to a carbon vision score module which uses the real-time offgas CO concentration to calculate a third carbon composition, which will be discussed in greater detail hereinbelow.

In addition to transmitting the calculated data to an HMI, including the calculated carbon concentration of the heat, all of which is transmitted as an output signal designated as “B” in FIG. 1, the metallurgical model module further checks for existence of invalid flame conditions such as, by way of non-limiting example, the presence of a moving object in front of the flame; alloy combustion; or removal of a AOD vessel cover between the camera and flame. If one or more of such invalid conditions exist and are detected, then the fuzzy logic module does not perform its fuzzy logic methodology on the incoming flame parameters for the purpose of avoiding inaccurate calculations. If no invalid condition is detected by the metallurgical model module for the current image of the flame, then the integrity of the flame conditions is presumed valid, and the metallurgical model will communicate to the fuzzy logic module to begin performing its decision logic on the flame parameters.

The fuzzy logic module performs certain decision logic functions based on the incoming, validated flame parameters. As mentioned hereinabove, the real-time flame parameters are presumed valid if the fuzzy logic algorithm has not received a signal from the metallurgical model corresponding to one or more real-time invalid conditions present in the flame. Non-limiting examples of the incoming flame parameters received from a camera include hue (referred to as “h”), saturation (referred to as “s”), value (referred to as “v”), and percent color (referred to as “%Color” or number of pixels). H, s, v and % color are typical parameters in flame image analysis as known in the art.

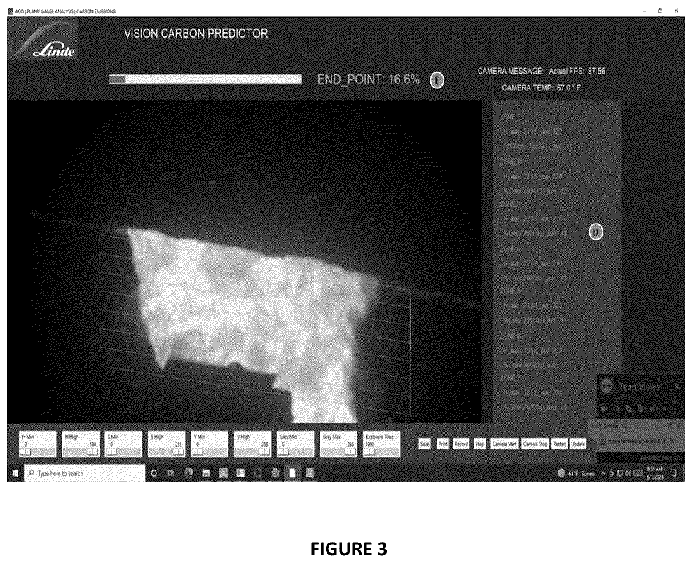

Hue is measured on a scale of 0-179, saturation and value are measured on a scale of 0-255, and %color is measured on a scale of 0-100. The decision logic algorithm partitions the flame into zones. In one example and as shown in FIG. 3, the flame is partitioned into seven zones as part of a fuzzy logic method for establishing a numerical carbon score for each zone and a resultant carbon score of the entire flame image (i.e., endpoint carbon score) based on the foregoing mentioned parameters of the flame image. FIG. 3 shows h, number of pixels (from which % color is calculated), and s for each of the seven zones (v is not shown in this particular partitioned flame image of FIG. 3).

Each zone is subject to a fuzzy logic methodology to characterize each of h, s v, and % color as “good,” “medium” or “bad” from which a corresponding numerical carbon score for each zone is determined. The numerical carbon score is a dimensionless parameter that is indicative of the flame characteristics for that zone. Generally speaking, the higher the numerical carbon endpoint score, the lower the carbon content, and vice versa. The methodology is based upon the Mamdani fuzzy system theory described by Mendel (J. M. Mendel, “Uncertain Rule-Based Fuzzy Systems Introduction and New Directions”, 2^{nd} Ed, Springer, 2017), incorporated herein by reference in its entirety. The Mamdani fuzzy system theory is implemented using the Python library skfuzzy (https://pythonhosted.org/scikit-fuzzy/), which is also incorporated herein by reference in its entirety, and represents a collection of fuzzy logic algorithms for use in the SciPy Stack, written in the Python computing language, as known in the art.

Utilizing the theory and techniques in the Mamdani fuzzy system and the Python library skfuzzy, a system of 53 fuzzy logic rules is developed by the inventors and applied to each of the 4 flame parameters (h, s, v and percent color) within each of the zones of the flame to quantify each zone with the corresponding numerical carbon score. The system of 53 fuzzy logic rules are structured with the following decision logic to enable numerically assigning a carbon score to each of the zones: (Rule 1) if h, s, v and % color are “good,” then the score is high; (Rule 2) if h, s, v and %color are “bad,” then the score is low; (Rule 3) if h, s, v are “medium,” then the score is medium; (Rules 4-7) if any three of the four flame parameters values are “good,” then the score is high; (Rules 14-17) if any three of the four flame parameter values are “medium,” then the score is medium; (Rules 18-23) if any two of the four flame parameter values are “bad” and the other two flame parameters are “medium,” then the score is low; (Rules 28-43) if any two of the four flame parameter values are “good” and the remaining two flame parameters are “bad” and “medium” or the remaining two flame parameters are “medium,” then the score is medium; and (Rules 44-53) if any two of the four flame parameter values are “medium,” a third flame parameter is “good” and a fourth flame parameter is “bad,” then the score is medium.

It should be understood the descriptors “good,” “medium” or “bad” for each of h, s, v and % color refer to the qualitative characterization of the flame image parameter, analogous to expressing a temperature as “cold” or “hot.” The fuzzy logic-based rules described hereinabove assign a final descriptor of “good,” “medium” or “bad” for the entire flame image. The inventors have created sigmoidal functions utilizing the Python library skfuzzy for each of h, s, v and % color that convert the qualitative descriptors into low, medium and high regimes from which corresponding carbon score values (ranging from 0.0 to 1.0) for each of the seven zones for each of h, s, v and % color is determined. The exact ranges for “good,” “medium” and “bad” for h, s, v and % color is based on the sigmoidal functions and have a tendency to vary based on the specific steel making process. To ensure reasonable characterization of the zones of the flame image in a typical AOD process, the inventors have derived customized limits in the sigmoidal function for values that are “good”, “medium” and “bad” based on their empirical observation and analysis. These limits exist for each zone for h, s, v and % color and for the combination of the zones. In this embodiment, the present invention utilizes the combination of the seven zones by aggregating each of the corresponding numerical carbon scores of the zones of the flame into a single endpoint carbon score for the flame. The carbon scores for each of the zones is converted to a single endpoint carbon score of the entire flame by utilizing a mathematical model in the Python library skfuzzy. The endpoint carbon score, when expressed as a percentage, represents the resultant carbon score of the flame that is a single value being a dimensionless parameter having a value greater than 0 and below 100.

It should be understood that the decision logic may be carried out by partitioning the flame into more or less than seven zones. Further, although the flame image is partitioned into seven zones, any portion of one or more of the partitioned zones may be used to carry out the decision logic described hereinabove, based, at least in part, on the particular AOD process.

Alternatively, it should be understood that the present invention can be carried out by utilizing the total flame image rather than partitioning the flame image into zones to determine an endpoint carbon score for the flame. Under such scenario, the system as shown in FIG. 3 does not partition the flame image into any zones, but, rather, forms an outer box surrounding the flame image to define the region within which the fuzzy logic analysis is carried out as mentioned hereinabove. In such an embodiment, average values for h, s, v and % Color for the entire flame image surrounded by the outer box are utilized.

The endpoint carbon score is transmitted as an output from the decision logic module and is designated as “E” in FIG. 1. A higher numerical carbon endpoint score of the entire flame image represents a lower carbon content, and vice versa. However, this carbon endpoint score itself is not a reliable indicator for an operator to act upon to determine when the carbon endpoint value is reached. The carbon endpoint score may not always correlate to the actual carbon as measured in a sample of the heat being below the minimum product specification.

To improve the reliability of estimating the improved carbon endpoint value, the present invention implements a vision carbon module that is configured to receive (i) the endpoint carbon score of the flame output (designated as “E” in FIG. 1) from the decision logic module and (ii) the calculated concentration of offgas CO from the metallurgical model module. The carbon vision module utilizes both pieces of data to generate a carbon final score value. In particular, the offgas CO is converted to a soot factor based on the soot equilibrium concentration in the flame, as CO by itself cannot reliably used to generate the carbon endpoint value. The soot factor is a normalized concentration that is indicative of the estimated amount of soot in the flame during the AOD process. The soot factor ranges from 0 to 0.5. The carbon vision module multiplies a mathematical function of the soot factor by a mathematical function of the endpoint carbon score of the flame to produce a final carbon score. The mathematical function of the soot factor allows a better fit of final carbon score data to the calculated carbon concentration. The carbon concentration determined from the empirical correlation is transmitted to an HMI as designated by “C” in FIG. 1.

The correlation of the final carbon score of the flame from the carbon vision module to a carbon concentration in the steel has been determined by an empirical linear relationship that has been previously created by fitting carbon scores from several heats plotted on a logarithmic x-axis with their corresponding carbon content calculated values determined from the carbon vision module that is plotted on a logarithmic y-axis. The empirical line is manually fitted to the generated data of carbon score and corresponding calculated carbon concentrations and exhibits substantially the same negative slope as the data. Backtesting of the fitted line validated its accuracy. The negative slope of the linear line means that an increase in the carbon score means a decrease in the carbon value. The adequate fitting of the data ensures the calculated carbon value can be estimated with accuracy from carbon scores. The determination of this preexisting correlation between the final carbon score and the calculated carbon content for several heats does not need to be repeated at a given AOD furnace every time that the AOD furnace is operated.

In a preferred embodiment, as part of the present invention, each of the 3 calculated carbon values based on their respective modules are preferably adjusted for inherent error therein. The system adjusts the calculated carbon values by a predetermined error, which is the difference between the measured carbon sample and the calculated carbon value for a particular heat. Statistical analysis of the historical error values is utilized to determine the error of the calculated carbon value. Specifically, the statistical analysis is implemented utilizing an open-source machine learning library to create a machine learning linear model at a predefined confidence level, predefined prediction interval or a fraction of the predefined confidence level or a fraction of the predefined prediction interval. The error is automatically adjusted by the present invention as new calculated carbon concentrations are determined in real-time during the AOD process from each of the 3 modules. In this manner, the system of the present invention adjusts upwards or downwards each of the carbon calculated values based on the unique historical error data exhibited by each of the 3 modules (i.e., IRS module, metallurgical model module and decision logic module).

The historical error is calculated by a confidence interval or a prediction interval or a fraction of the confidence interval or the prediction interval, followed by adding the historical error to the first carbon composition, the second carbon composition and the third carbon composition. Each of the first output signal, second output signal and third output signal corresponding to the error-adjusted first carbon, error-adjusted second carbon and error-adjusted third carbon composition can be subsequently transmitted to the HMI and/or utilized by the system of FIG. 1 to determine when to take a sample based on the criteria disclosed hereinbelow. As such, it should be understood that some or all of the carbon content values determined from the IRS, metallurgical and Vision modules of the present invention and as described below can be error-adjusted.

Having transmitted to the operator dashboard (HMI) a first carbon content value by the IRS module; a second carbon content value based on the metallurgical model module; and a third carbon content value based on the decision logic module, the system of FIG. 1 looks at each of the 3 values and compares each of the 3 values to a predetermined calculated target carbon value. The predetermined calculated target carbon value is defined as the minimum carbon product specification for the heat plus a fraction (i.e., varies between 0 to 1) of the difference between the maximum carbon product specification and minimum carbon product specification. The equation can be expressed as follows:

Target carbon value=Minimum carbon product specification+fraction*(Maximum carbon product specification−Minimum carbon product specification)

The predetermined calculated target carbon value is previously calculated by the system of FIG. 1 and is stored in the system as a setpoint value. The selection of the fraction remains fixed during the AOD operation but can be adjusted from time to time as needed and depends on balancing several factors, including AOD process costs with the ability to meet the carbon product specification, both of which are inversely related tradeoffs. The ability to meet the carbon product specification can depend on the specified grade of the particular steel product. In particular, a higher fraction means a higher target carbon concentration, which translates into relatively less carbon removal during the AOD process, which requires less gas consumption and associated costs. Less gas consumption and costs are achieved at the expense of the target carbon concentration having a value well above the minimum carbon specification and in some instances approaching the maximum carbon product specification. Conversely, a lower fraction means a lower target carbon concentration, which beneficially results in the target carbon concentration having a value being closer to the minimum carbon product specification. However, the lower target carbon concentration is achieved at the expense of relatively more carbon removal required during the AOD process, which requires more gas consumption and associated costs. Taking into account the aforementioned design and cost considerations, the exact fraction to use for a given AOD process therefore depends, at least in part, on striking an optimal balance between process costs and the ability to meet the applicable carbon product specification.

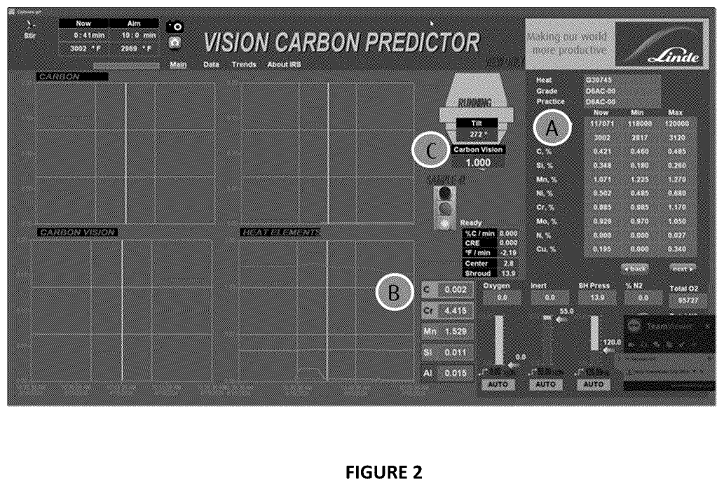

If the system determines that any 2 of the 3 carbon content values are below the predetermined calculated target carbon value of the steel product, then the system conveys a visual signal to the HMI screen (e.g., a green light as shown in FIG. 2) which notifies the operator that the improved carbon endpoint value has been reached. This alert notification will prompt the operator to stop flow of all the gases to the AOD process and shut down the process and tilt the furnace to enable the operator to take a sample of carbon for measurement from the molten steel bath in the AOD vessel. If none of the 3 carbon content values are below the predetermined calculated target carbon value or if only 1 of the 3 values are below the predetermined calculated target carbon value, then the system will provide a visual display to the HMI (e.g., a red light) informing the operator that the AOD process is not ready to be stopped to take a sample. Still further, the system may display a visual signal (e.g., yellow light), if the green or the red-light conditions are not met, that is indicative to the operator that 2 of the 3 values are relatively close to a carbon level that is below target carbon value. The visual status display eliminates the need for the operator to look at the 3 different carbon content values on the HMI during the AOD process. In a preferred embodiment, the predetermined calculated target carbon value is 0.1%.

FIG. 2 shows a representative dashboard updated in real-time that an operator utilizes to carry out the AOD process, whereby the dashboard includes a visual output that indicates when to take a carbon sample as described hereinabove.

When the operator receives the visual alert notification to take a sample, the operator can stop flow of all gases to the AOD furnace, tilt the furnace, and take a sample of the molten bath. The measured carbon content preferably is a concentration that is below the predetermined calculated target carbon value. By creating a carbon measured concentration that is below the predetermined calculated target carbon value, the subsequent downstream alloy additions which introduce marginal amounts of carbon into the product ensures that the final carbon product specification is between the minimum and maximum carbon specification.

A primary benefit of the present invention is its ability to systematically and consistently achieve with high probability a carbon measured content that is below a calculated target value without requiring the user to speculate based on his or her own experience and judgment when the AOD process may have reached a carbon endpoint value. Additionally, the user-friendly HMI allows the operator to solely focus on the graphical display of whether a sample for carbon measurement should be taken at a particular time during the AOD process instead of focusing on the real-time carbon concentrations designated at “A,” “B” and “C”.

While it has been shown and described what is considered to be certain embodiments of the invention, it will, of course, be understood that various modifications and changes in form or detail can readily be made without departing from the spirit and scope of the invention. For example, more or less than 3 modules may be used in combination with the vision carbon module. It is, therefore, intended that this invention is not limited to the exact form and detail herein shown and described, nor to anything less than the whole of the invention herein disclosed and hereinafter claimed.

1. A method of determining an improved carbon endpoint value during an argon oxygen decarburization (AOD) process, comprising:
initiating the AOD process by feeding a predetermined weight of a molten metal charge, and flowing oxygen gas, nitrogen gas and argon gas in controlled ratios into an AOD vessel;
generating a flame produced by chemical reactions above the molten metal charge and a slag charge;
removing carbon from a molten metal bath produced in the AOD vessel from the molten metal charge;
calculating a first carbon composition in the molten metal bath in a controller;
generating a first output signal corresponding to the first carbon composition and transmitting said first output signal to a human-machine interface (HMI);
calculating a second carbon composition in the molten metal bath based on receiving operating parameters from the controller and/or an on-premise plant database;
generating a second output signal corresponding to the second carbon composition and transmitting said second output signal to the HMI;
determining a third carbon composition in the molten metal charge based on performing fuzzy logic analysis on parameters of the flame and receiving a calculated value of CO;
generating a third output signal corresponding to the third carbon composition and transmitting said third output signal to the HMI; and
determining in real-time that the improved carbon endpoint value is reached when at least a first value and a second value corresponding to any of the first carbon composition, the second carbon composition and the third carbon composition are below a predetermined calculated target carbon value.

2. The method of claim 1, wherein the carbon endpoint value is at or below 0.1 wt. %.

3. The method of claim 1, wherein the carbon endpoint value is at or below 0.07 wt. %.

4. The method of claim 1, further comprising the step of determining that a carbon content of a measured sample is below the predetermined target carbon value.

5. The method of claim 1, further comprises converting the calculated value of CO to a concentration of soot in the flame, followed by determining a final carbon score value, said final carbon score value derived from a multiplication product of a first mathematical function of a normalized concentration of soot in the flame and a second mathematical function of an endpoint carbon score of the flame.

6. The method of claim 1, further comprising repeating the steps of calculating the first carbon composition and the second carbon composition and determining the third carbon composition during the AOD process in real-time.

7. The method of claim 1, wherein the difference between a carbon content of a measured sample and the predetermined calculated target carbon value is 0.1% or less.

8. The method of claim 1, further comprising:
generating a visual output to the HMI that indicates a sample of the molten steel bath in the AOD vessel is ready to be obtained when at least the first value and the second value corresponding to any of the first carbon composition, the second carbon composition and the third carbon composition are below a predetermined calculated target carbon value;
stopping the flow of oxygen gas, nitrogen gas and argon gas to the AOD vessel; and
obtaining a sample from the molten steel bath inside the AOD vessel; and
measuring a carbon content of the sample, wherein said sample has a measured carbon concentration below the predetermined calculated target carbon value.

9. The method of claim 1, wherein the step of performing the fuzzy logic comprises the steps of:
verifying an absence of receiving a signal corresponding to one or more conditions in the AOD vessel being invalid, and in response thereto;
receiving parameters of a flame;
dividing the flame into zones;
creating fuzzy logic rules to characterize the parameters in each of the zones into a corresponding numerical carbon score; and
aggregating each of the corresponding numerical carbon scores of the zones of the flame into an endpoint carbon score for the flame, wherein said endpoint carbon score represents the resultant carbon score of the flame that is a single value being a dimensionless parameter having a value greater than 0 and below 100.

10. The method of claim 1, wherein the third carbon composition is derived from a carbon final score, said carbon final score being a single value and a dimensionless parameter having a value greater than 0 and below 100.

11. The method of claim 1, wherein said one or more parameters of the flame in the AOD vessel includes colors of the flame and a size of the flame obtained from image analysis of the flame.

12. The method of claim 1, further comprising:
converting the parameters of a single image of the flame into an end-point score;
utilizing the calculated value of the CO concentration to estimate a normalized soot concentration in the flame;
determining a final carbon score for the flame based on a multiplication product of the endpoint score and as function of the normalized soot concentration in the flame; followed by
empirically correlating the final carbon score to a third carbon composition in the molten metal bath.

13. The method of claim 1, wherein the step of performing the fuzzy logic analysis on the flame occurs in response to validation of all conditions of the flame, and if one or more conditions of the flame are determined to be invalid, the step of performing the fuzzy logic analysis on the flame is delayed until determining said validation of all conditions of the flame, thereby ensuring integrity of the third carbon composition that is subsequently determined.

14. The method of claim 1, further comprising:
determining a first historical error for said first carbon composition and adding said first historical error to said first carbon composition to produce an error-adjusted first carbon composition;
determining a second historical error for said second carbon composition and adding said second historical error to said second carbon composition to produce an error-adjusted second carbon composition;
determining a third historical error for said third composition and adding said third historical error to said third carbon composition to produce an error-adjusted third carbon composition; and
wherein said first, second and third historical error is calculated by a predefined confidence interval or a predefined prediction interval or a fraction of the predefined confidence interval or a fraction of the predefined prediction interval.

15. A method of determining a carbon composition during an argon oxygen decarburization (AOD) process, comprising:
initiating the AOD process by feeding a predetermined weight of a molten metal charge, and flowing oxygen gas, nitrogen gas and argon gas in controlled ratios into an AOD vessel;
generating a flame produced by chemical reactions above the molten metal charge and a slag charge;
removing carbon from a molten metal bath produced in the AOD vessel from the molten metal charge bath produced in the AOD vessel from the molten metal charge;
receiving a fuzzy logic output characterized as a carbon end-point score of the flame;
receiving a calculated value for a composition of CO;
utilizing the calculated value for the composition of CO to calculate a soot concentration in the flame;
utilizing a function of the normalized soot concentration to convert the end-point carbon score into a final carbon score of the flame that is a single value being a dimensionless parameter having a value greater than 0 and below 100; and
empirically correlating the final carbon score to a carbon content in the molten metal bath.

16. The method of claim 15, wherein the carbon content is error-adjusted and then transmitted to a human-machine interface (HMI).

17. The method of claim 15, wherein the carbon content is updated at predetermined time intervals ranging from 5 to 20 seconds.

18. The method of claim 15, wherein the empirically correlated carbon content deviates from a carbon content of a measured sample by 0.1% or less.

19. A method of estimating an improved carbon end point value during an argon oxygen decarburization (AOD) process, comprising:
feeding a predetermined weight of a molten metal charge, a slag charge and flowing oxygen gas, nitrogen gas and argon gas in controlled ratios into an AOD vessel;
generating a flame produced by chemical reactions above the molten metal charge and the slag charge;
removing carbon from a molten metal bath produced in the AOD vessel from the molten metal charge;
receiving an alert notification that a sample of carbon from the molten metal bath in the AOD vessel is ready to be obtained; and in response thereto;
stopping flow of the oxygen gas, the nitrogen gas and the argon gas to the AOD vessel;
obtaining the sample of the carbon from the molten steel bath in the AOD vessel; and
measuring the carbon content in the sample; and
determining the measured carbon content in the sample is reduced to a level that is below a predetermined calculated target carbon value.

20. The method of claim 19, wherein the alert notification is a visual display that does not require observing a real-time concentration trend of carbon concentration in the molten metal charge.

21. The method of claim 19, wherein the alert notification is triggered when at least two of three real-time carbon calculated concentrations appearing on a human-machine interface (HMI) are determined to be below the predetermined calculated target carbon value.

22. The method of claim 19, wherein a single sample of the carbon from the molten steel bath in the AOD vessel is obtained to determine that said carbon in the molten metal charge has a measured value that is below the predetermined calculated target carbon value.

23. A method of determining an improved carbon endpoint value during an argon oxygen decarburization (AOD) process, comprising:
initiating the AOD process by feeding a predetermined weight of a molten metal charge, and flowing oxygen gas, nitrogen gas and argon gas in controlled ratios into an AOD vessel;
generating a flame produced by chemical reactions above the molten metal charge and a slag charge;
removing carbon from a molten metal bath produced in the AOD vessel from the molten metal charge;
calculating a first carbon composition in the molten metal bath in a controller;
calculating a second carbon composition in the molten metal bath based on receiving operating parameters from the controller and/or an on-premise plant database;
determining a third carbon composition in the molten metal charge based on performing fuzzy logic analysis on parameters of the flame and receiving a calculated value of CO; and
generating a visual output to the HMI that indicates a sample of the molten steel bath in the AOD vessel is ready to be obtained when at least a first value and a second value corresponding to any of the first carbon composition, the second carbon composition and the third carbon composition are below a predetermined calculated target carbon value.

24. The method of claim 23, wherein said first carbon composition, said second carbon composition and said third carbon composition are adjusted by a corresponding first historical error, second historical error and a third said corresponding historical error based on performing statistical analysis of said corresponding first historical error, second historical error and third historical error.
